(19) United States
(12) Patent Application Publication
(10) Pub. No.: US 2008/0244627 A1
(43) Pub. Date: Oct. 2, 2008

(54) DISC TRANSPORT WITH CAROUSEL

(76) Inventors: Dale K. Kubin, San Diego, CA (US); Nathan P. Scherdin, San Diego, CA (US)

Correspondence Address: DOBRUSIN & THENNISCH PC, 29 W LAWRENCE ST, SUITE 210, PONTIAC, MI, 48342, US

(21) Appl. No.: 11/844,598

(22) Filed: Aug. 24, 2007

Related U.S. Application Data
(60) Provisional application No. 60/908,029, filed on Mar. 26, 2007.
(60) Provisional application No. 60/945,211, filed on Jun. 20, 2007.

(51) Int. Cl. G11B 17/03

(52) U.S. Cl. 720/601

(57) ABSTRACT

The present invention provides an improved media device having an improved design for providing efficient operation and improved print and recording speed to one or more storage devices. In one aspect, the present invention provides a media device having a rotatable disc carousel that has a plurality of disc receptacles for storage of storage media and a disc transport that is configured for movement along multiple disc engagement axes for transportation of storage media to the plurality of receptacles of the rotatable disc carousel and to the media components of the media device. In another aspect, the present invention provides a media device having a disc carousel with rotational means adapted to operate independently of the disc transport. In yet another aspect, the present invention meets the above needs by providing a media device having printer means adapted to operate independently of a disc transport.

### CLAIM OF PRIORITY

The present invention claims the benefit of the priority of the filing date of U.S. Provisional Application Ser. No. 60/908,029 filed Mar. 26, 2007 and U.S. Provisional Application Ser. No. 60/945,211 filed Jun. 20, 2007, which are herein incorporated by reference for all purposes.

### TECHNICAL FIELD

The field of the present invention relates to media devices, more particularly to disc publishing devices adapted to print to a plurality of discs and optionally record information thereto.

### BACKGROUND OF THE INVENTION

Media device manufacturers currently provide consumers with disc publishing devices configured for processing media (such as storage discs, or otherwise). Such processing includes printing, recording, or otherwise using media components that are typically separate from one another, which requires the use of a transport mechanism for movement of storage media to components of the publishing devices for processing therein. Recently, media device manufacturers have attempted to combine the features into a single disc-publishing device for both transporting and processing media.

However, the disc publishing devices have failed to provide an efficient user-friendly disc-publishing device. As an example, in order for these disc-publishing devices to produce multiple processed discs with limited user interaction, they require the use of disc transport mechanism with one axis of movement. This limited movement is necessary because the typical disc publishing devices occupy small spaces that require few media components and media storage sites for processing of media discs. As such, if the user wishes to process multiple discs, the user must continually replenish the disc-publishing device with blank media as a result of minimal media storage sites.

Accordingly, at a minimum, there is a need for a more efficient disc-publishing device capable of printing and recording to multiple media. In addition, there is a need for a disc printing device capable of storing large amounts of blank and processed media and a disc transport mechanism capable of accessing these and other components of a disc publishing device.

### SUMMARY OF THE INVENTION

The present invention overcomes the drawbacks of the prior art by providing a media device having an improved design, which provides more efficient operation and orientation of the device's components for the handling and use of disc media. Advantageously, this new design further provides an economically priced media device, which is advantageously sized for an individual use, small business, or otherwise, and which is more user friendly than prior art media devices.

In one aspect, the present invention meets the above needs by providing a media device having a disc transport that is moveable in at least two axes, which enables the engagement mechanism to align with several different disc picking engagement points, thereby making the media device and more specifically, the storage media more accessible to an end user. Further, the integrated disc carousel provides multiple disc storage receptacles for separating the blank discs from the processed discs. The arrangement of the disc transport to the other components of the media device having aligned points of engagement in either a generally vertical axis or generally horizontal axis as in the present invention allows for a very compact media device. Accordingly, the improved disc transport having at least two axes of movement as in the media device of the present invention provides a more efficiently operated and oriented compact device.

### BRIEF DESCRIPTION OF THE DRAWINGS

FIG. 1 is a perspective view of the present invention.

FIG. 2 is a top view of the present invention.

FIG. 3 is a side view of the present invention.

### DETAILED DESCRIPTION OF THE INVENTION

The present invention provides a media device and method for printing and/or recording to one or more storage devices including, but not limited to: compact discs, digital video discs, mini discs, the like, combinations thereof or otherwise. Advantageously, the device is adapted to provide printing to a disc, which preferably is separate in operation to that of a transport mechanism (e.g., the disc transport and printing mechanism are not movably attached) as disclosed in U.S. application Ser. No. 11/335,381 entitled “Printer” is herein incorporated by reference. Accordingly, the media device is adapted to simultaneously perform multiple task (e.g., printing to a first disc while transporting a second disc or otherwise). This separation of operation provides more efficient functioning of the device resulting in faster printing capabilities and other advantageous as implicitly or explicitly disclosed herein.

Advantageously, the device may further include a recording means for recording digital information to a storage device, such as a compact disc, digital video disc, mini disc or otherwise. Furthermore, it should be appreciated that the device is capable of simultaneously printing, recording, or movement of one or more discs. Still further, it should be appreciated that the media device may include more than one recording, printing and/or transportation means. Other configurations should be appreciated. Accordingly, in view of the independent movement of the transportation mechanism, it should be appreciated that the device is adapted to simultaneously print to a first disc, record digital information to a second, third, fourth, and fifth disc and provide transportation to a sixth disc.

In yet another embodiment, the media device 10 further comprises a rotatable disc carousel 44, which contains two or more disc receptacles, preferably four receptacles, having generally vertical walls or rods for stacking the storage discs. The two or more disc receptacles may be removable or fixedly secured to the rotatable disc carousel. Suitable drive means for the rotatable disc carousel include mechanical, electrical, pneumatic, magnetism, the like or otherwise.

The rotatable disc carousel 44 allows a user to place a plurality of discs in a supply receptacle, which is accessible by the disc transport 14. The discs are then printed and/or recorded to and subsequently returned to the rotatable disc carousel, and preferably placed in a storage receptacle for removal by a user. Multiple receptacles allow for additional media discs, which in turn reduces the need for user intervention thereby increasing productivity and the amount of processed discs. More specifically, a user can increase the number of blank discs at one or more supply receptacles and retrieve a plurality of completed discs at corresponding one or more storage receptacles (e.g., recorded and/or labeled) without substantial interruption of the operation of the media device. In a preferred embodiment, the rotatable disc carousel has a first and second supply receptacle, 46 and 48 and a first and second storage receptacle, 50 and 52, respectively. Additionally, it is appreciated that multiple storage receptacles may be adapted to comprise differently processed discs. For example, the rotatable disc carousel may comprise a first storage receptacle including type A processed discs having a first label and a first recording and a second storage receptacle including type B processed discs having a second label and a second recording.

For example, the controller is configured to independently control the rotation of the rotatable disc carousel and/or the movement of the disc transport as discussed herein. As such, once a blank disc has been respectively processed as a type A or type B processed disc, the controller controls the disc transport, the rotatable disc carousel, or both so that all disengaged type A processed discs are placed in a first storage receptacle and all disengaged type B processed discs are placed in a second storage receptacle. Accordingly, the rotatable disc carousel may include a plurality of disc receptacles and any combination of the one or more supply receptacles and the one or more storage receptacles for discs produced using similar or different processes.

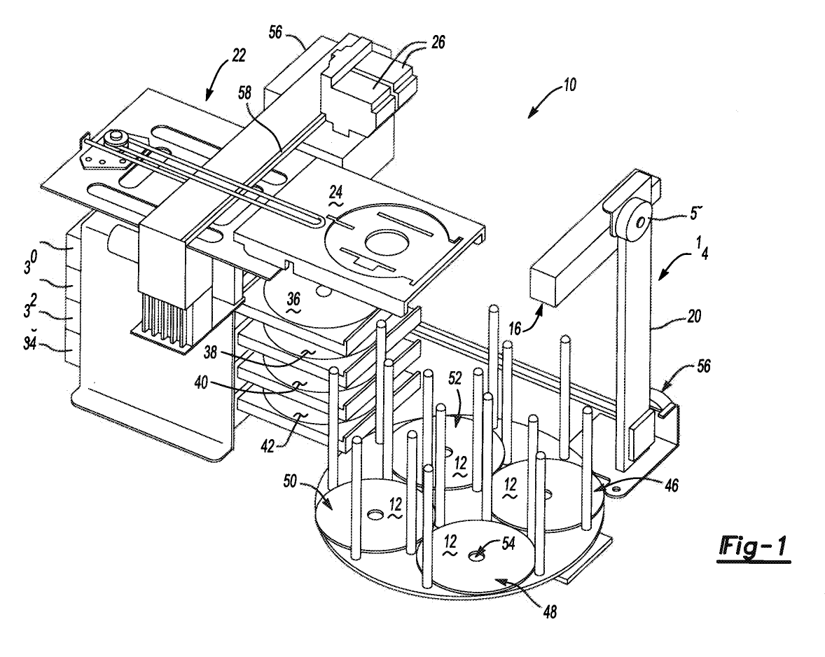

Referring to the drawings, exemplary embodiments and features of the present invention are shown. The present invention provides a media device 10, (FIG. 1), for copying, printing, and/or recording of one or more storage devices, such as disc 12. The device includes a housing (not shown) adapted to provide support and enclosure for one or more of the components of the device. Preferably, the housing is relatively small such that it can be placed upon a desktop or the like. However, the housing may be substantially larger as it is contemplated that the device may comprise numerous components (e.g., recording devices, media devices, or otherwise), which may or may not be alike.

The media device includes a disc transport 14 adapted to engage and move one or more discs, preferably one at a time. The disc transport 14 has independent movement capabilities and is controlled by a controller, which may be attached to the disc transport or may be part of another component of the media device 10. The disc transport is movably mounted to a first slide member 18, which extends along at least a portion of the media device and is mounted or otherwise secured thereto. Preferably, the first slide member includes a bearing surface for minimizing friction between the disc transport and the first slide member. The mounting of the disc transport to the first slide member provides slidable movement of the disc transport along a first axis such that a disc may be moved substantially along the same path. The rotatable disc carousel is adapted to receive and/or store a plurality of discs, as discussed herein. Accordingly, preferably the disc transport is configured with a disc engagement mechanism 22, adapted to attach to a portion of a disc, and preferably in a disc hole 54 formed therein, for subsequent movement of the disc along the first axis.

As previously mentioned, the disc transport 14 is adapted to move along a substantial portion of the first slide member. Accordingly, the device further includes drive means linkably attached to the disc transport, via a linkage or otherwise, to provide a suitable force to move the disc transport to various points along the first slide members. Suitable drive member may include a stepper motor or other suitable drive members used for moving a printer component along a bearing surface or the like. Suitable linkages include belts, cables, chains, screws, the like or otherwise. In a preferred embodiment, the linking mechanism comprises a belt. However, it should be appreciated that numerous types of drive assemblies and linkages are available and may be used, as are commonly utilized in the design of inkjet printers.

The first slide member 18 may comprise of any member adapted to guide an attached member along a portion of its length, width or otherwise. Suitable guiding feature include tracks, shafts, rails, grooves, the like or otherwise. In a preferred embodiment, the first slide a member comprises an elongated member adapted to fit within a recess and/or opening formed in the housing. Suitable elongated members include shafts, rods, beams, rails, the like or otherwise.

The disc transport is further configured with means for movement along a second slide member 20 that is generally perpendicular to the first axis. The second slide member is similarly configured as the first slide member, as discussed herein, for movement generally perpendicular to the first axis of the disc transport along a second axis. Preferably, this perpendicular movement is generally vertical with respect to the media device; however, other directions are within the scope of the invention. Advantageously, this movement allows the engagement mechanism to be lowered over a disc for engagement with the same. Subsequently, the disc may be lifted away from the rotatable disc carousel along the second slide member and moved along the first slide member about the first axis, to a desired location. Upon arrival to the desired location (e.g., a print location, record location, final destination or otherwise), the disc may be lowered to a select height and released for further processing of the disc or otherwise. It should be appreciated that, in at least one embodiment, as a result of decoupling of the disc transport from the processing station (e.g., print assembly) and the recording devices, the disc transport is given greater movement flexibility for allowing greater vertical movement thereby allowing for placement of a greater number of discs in the disc receptacles at the rotatable disc carousel, as discussed herein.

In one embodiment, the plurality of disc receptacles located within the rotatable disc carousel may be removable, interchangeable, or fixedly secured to the rotatable disc carousel and are adapted to receive and hold discs. In another embodiment, the plurality of disc receptacles and/or the rotatable disc carousel are configured to rotate thereby aligning itself with a disc attached to the engagement mechanism of the disc transport, when located thereabove. The plurality of disc receptacles preferably are adapted to hold at least ten discs, more preferably at least twenty-five discs, and even more preferably at least fifty discs.

Vertical movement of the disc transport may be achieved using any suitable drive means. Suitable drive means include mechanical, electrical, pneumatic, magnetism, the like or otherwise. In one preferred configuration, vertical movement of the disc transport is achieved similarly to drive means as discussed above along a second slide member 20 that is generally vertically orientated. In this configuration, the disc engagement mechanism is movable with respect to the first slide member 18, wherein the engagement mechanism is attached or otherwise connected to the vertically orientated drive assembly, which is activatable upon an application of a current therethrough. It should be appreciated that the drive assembly may be activated in an opposite direction (e.g., from the second to the first position) to return the disc engagement mechanism to its original, previous, or other position. In another configuration, vertical movement of the disc engaging mechanism may be achieve through the use of a solenoid feature, stepper motor or through any other suitable means.

Preferably, the disc transport is configured with a disc engagement mechanism 16, (FIGS. 1 and 4), adapted to attach to a portion of a disc, and preferably in a disc hole formed therein, for subsequent movement of the disc along the first and second axes. The engagement mechanism includes engagement fingers, which when combined form a diameter that generally corresponds to the disc hole formed in the disc 12 and are adapted to move relative to each other. In a first position, the fingers are in a closed position wherein the resulting diameter of the fingers is less than the diameter of the disc hole. Accordingly, the fingers can move into the disc hole without substantial interference. In a second position, the fingers separate and form a diameter that is equal to, or greater, than the diameter of the disc hole such that the fingers engage the inner walls of the disc hole to prevent the disc from disengaging from the disc engager. It should be appreciated that the fingers engage the interior walls of the disc hole and optionally form a friction fit through an application of pressure by the fingers, support the disc from its underside using flanges on one or both fingers, or otherwise and combinations thereof. Optionally, the one or more of the engagement fingers may include a tapered end portion for assisting in the alignment and insertion of the fingers into the disc hole.

In view of the foregoing, it should be appreciated that upon engagement with a disc, e.g., movement of the fingers from a first position to a second position, the disc can be moved along the first slide member to different regions of the media device 10. Accordingly, when the disc transport reaches a desired location, the engagement fingers move back to the first position, thereby resulting in the disengagement of the disc with the engagement mechanism.

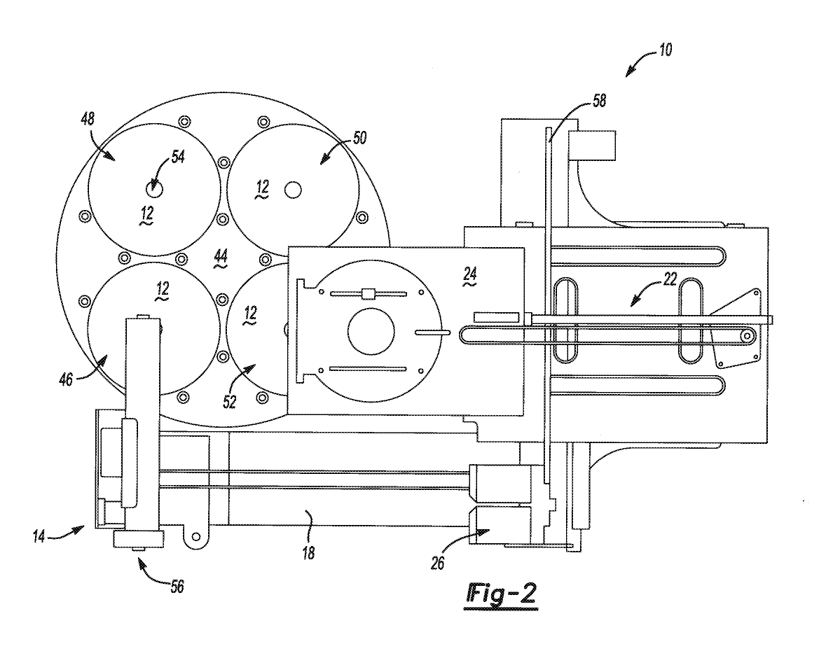

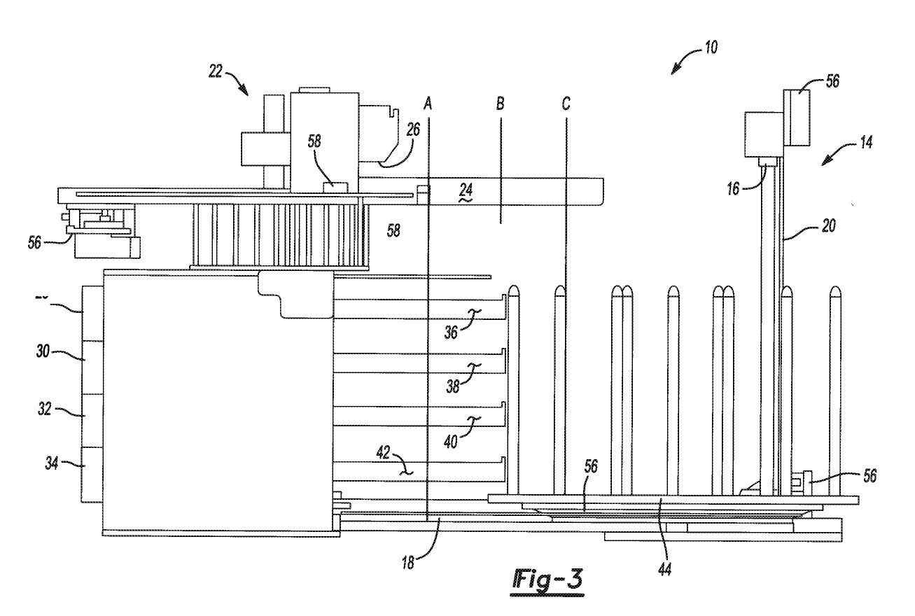

In operation, the media device 10 is configured for multi-axis disc engagement. Accordingly, the disc transport is adapted for movement along at least a first axis and a second axis for engagement of discs at several disc engagement sites such as the disc receptacles 46, 48, 50, and 52 of the rotatable disc carousel 44, the print tray 24 of the processing station 22 and the recording trays 28, 32, 36, and 40 of the recording devices 28, 30, 32, and 34, (FIG. 3). For example, in one embodiment, the print tray 24, (FIG. 2), is not in alignment with any of the disc receptacles 46, 48, 50, and 52 or the movable recording trays 28, 30, 32, and 34. As such, the disc transport is configured to move to multiple engagement points for disc engagement or disengagement. To accommodate the multiple engagement points, the disc transport 14 moves the engagement mechanism along the first and/or second axes to approximate itself to the engagement points A, B, C, and D, (FIG. 3), thereby positioning the engagement mechanism 16 above one of the components of the media device. For exemplary purposes, the engagement point A is in alignment over the plurality of recording trays 28, 30, 32, and 34, the engagement point B is in alignment over the print tray 24, and the engagement points C and D are in alignment over the supply and storage receptacles, 46, 48, 50, and 52, respectively. Once positioned over the receptive “extended” print or recording tray, the disc transport lowers the engagement mechanism, which is already generally aligned with the tray therebelow, and the disc 12 is engaged either to be removed from the tray or disengaged into the tray for further processing.

In order to provide access for the engagement mechanism 14 to each of the disc receptacles 46, 48, 50, and 52, the disc carousel 44 rotates by mechanical means clockwise or counter clockwise along a carousel axis, which is substantially parallel to the second axis. Once rotated into alignment with the engagement mechanism 16 of the disc transport 14, thereabove, the engagement mechanism 14 is lowered to the generally aligned disc receptacle 46, 48, 50, or 52 and the disc 12 is either engaged or disengaged. As a result of movement along the two axes, the disc transport 14 is able to increase its available engagement points such as in points A, B, C, and D, (FIG. 3).

With the addition of a rotatable disc carousel having a plurality of receptacles, the media device is further enhanced by way of an indexing feature, which enables the control unit of the media device to separate processed discs. For example, the media device is adapted to process discs having different printings, and/or recordings into separate storage receptacles. Accordingly, the controller of the media device will control the movement of the disc transport 14 and/or the rotation of the disc carousel to disengage completed discs into separate storage receptacles, based on what type of processing was completed, as discussed above. It is further appreciated that faulty discs, such as disc that were not processed completely, failed to be correctly processed, or otherwise may be separated into an additional receptacle on the rotatable disc carousel.

The present invention is further adapted to perform multiple tasks to create a final disc product. Of these tasks, one particularly useful task includes recording information to the disc for subsequent retrieval. Such information may include music, videos, files, or other types commonly recorded through optical means. Accordingly, in a one embodiment, the media device further includes a plurality of digital recording devices adapted to record information to a disc. The recording device is configured to receive a disc from the disc transport, subsequently record information to the disc and make the disc available to the disc transport for subsequent tasks or otherwise. It should be appreciated that the information to be recorded to the disc may originated from another component, input port, as described herein, or otherwise.

Referring to FIGS. 1 and 3, suitable disc recording devices 28, 30, 32, and 34, for recording digital information to a disc, are illustrated. The disc recording devices are mounted to the housing and preferably located adjacent to the first slide member. The disc recording devices 28, 30, 32, and 34 further include recording trays 36, 38, 40, and 42, respectively that extend below the printer assembly. In this exemplary embodiment, the recording trays are adapted to reside in a first retracted position, wherein information may be recorded, and extend to a second position for receiving and/or providing a disc to the engagement mechanism. It should be appreciated that movement of the tray may be achieved using common techniques used in compact disc and digital video disc players and recording devices, or otherwise.

In operation, each of the recording devices is configured to extend the respective recording tray to an extended position for receiving a disc from the disc transport. If not already located there, the disc transport moves an engaged disc to a position substantially over the recording tray of the respective recording device. The disc engagement mechanism lowers the disc into the recording tray and releases the disc. The engagement mechanism then moves away from the recording tray and the recording tray is retracted to the first position for recording. Upon completion of recording to the disc, the recording tray extends to an extended position so that the disc transport can retrieve the disc for further processing or otherwise. Accordingly, it is appreciated that the media device is capable of multiple simultaneous recordings to discs using the recording devices 28, 30, 32, and 34. It is further appreciated that the media device may include additional or fewer recording devices.

Another useful task that may be performed with the present invention includes printing a design, text or otherwise to a disc for identification purposes, or otherwise. Accordingly, the media device may further include a processing station adapted to print to a disc using common printing techniques (e.g., inkjet laser or otherwise). In a preferred embodiment, the processing station includes one or more print head 26 and ink cartridges having colors commonly associated with inkjet printing (e.g., black, white, reds, blues, greens, combinations there of as otherwise). The print heads are mounted to a print slide member 58, which preferably extends along at least a portion of the recording devices housing and is mounted or otherwise secured thereto. It should be appreciated that the print slide member may include any of the features of the first and second slide members. The mounting of the processing station 22 to the print slide member 58 provides movement along a print axis, which preferably is substantially perpendicular with the first axis but does not interfere with the movement of the disc transport located on the first and second slide members. It should be appreciated that the height of the disc transport and print slide member may be maximized to access an optimum amount of discs at the rotatable disc carousel or increase the optimum number of recording devices within the media device. Accordingly, this increases the amount of discs that can be stored at the disc receptacles and the amount of discs that can be processed simultaneously.

It should be appreciated that the print head 26 further includes a suitable drive means and linkages for movement of the print head along the second slide member. Suitable drive means and linkages may include any of the devices used for movement of the disc transport or any other suitable drive and/or linkage found in the art of printing devices and more particularly the drive configuration of print heads. Advantageously, the print heads are adapted to print to a disc portion located within the print tray.

The one or more print heads 26 are adapted for movement along the print slide member and are adapted for printing directly to a disc located therebelow. Accordingly, the processing station 22 further includes a print tray 24 adapted to receive a disc and provide movement therefore, which preferably is substantially perpendicular to the movement of the printer heads. Advantageously, the print tray is adapted for movement along an axis to effectuate printing. For example, in a preferred embodiment, the print tray is moveable to a first position, which is fully extended and a second position, which is fully retracted. It should be appreciate that during printing, the print tray will move between the first and second position to provide print capability throughout the entire disc located within the print tray.

Movement of the print tray 24 can be effectuated using any suitable drive mechanism and any linkage thereto adapted for specific positioning of the print tray, which may include reciprocal movement. Suitable drive mechanisms are known in the art of printing and may include stepper motors or otherwise. In a preferred embodiment, to effectuate specific positioning of the print tray, movement of the print tray is sequenced with the movement and printing of the print head. Preferably, the movement of the print tray and the print head are effectuated through a controller adapted to cause the print tray to move to one or more positions, as further discussed herein, so that the one or more print heads can print to a specified region of the disc.

In a preferred embodiment, one or more of the components of the media device are controllable through a controller. The controller of the media device may be included as a component of the media device or alternatively, the controller may be included with a separate component, e.g. not incorporated within the media device. However, in a preferred embodiment, the controller is adapted to receive a signal from a source, such as a computer or otherwise, such that function of the media device is based upon the received signal. Furthermore, preferably the controller causes synchronized operation of the components of the media device (e.g., printing, recording, movement or otherwise) to maximize print efficiency by minimizing cycle time of any task to be performed.

The controller of the media device may be programmed with one or more suitable software programs to assist in effectuating the printing of the media device and/or the recording of information onto a disc or otherwise. Preferably, the control device is adapted to be compatible with program languages such as C/C++, VisualBasic, Java, Pascal, Modula II, ADA, Fortran, Forth, or otherwise. Furthermore, other software may be included to control the device, perform maintenance thereto or otherwise.

In one exemplary method, the operation of the media device is demonstrated as follows. A user selects one or more tasks to be performed by the media device, via a user interface. As previously mentioned, such tasks may include recording to a disc, printing to a disc, or both. The user interface may be located proximate to the media device or remote to the media device (e.g., via a network connection, Internet or otherwise). It should also be appreciated that the user interface may comprise an integral component of the media device (e.g., located externally or otherwise).

Prior to assignment of a task to be performed by the media device, the user places one or more discs at the rotatable disc carousel, as discussed herein. Optionally, the amount of discs placed in the rotatable disc carousel at one or more disc supply receptacles correspond to the desired selected discs the user wishes to perform tasks to.

Through the user Interface, the user selects one or more tasks to be performed to one or more discs. Often, as discussed below, the task includes both the recording and printing of information. For example, the tasks may include transferring data from a source to one or more discs, in a digital format. In addition, the tasks may also include printing to the recorded discs, which advantageously corresponds to the information transferred to the disc. Once the tasks have been selected, one or more signals are transferred to the controller of the media device to effectuate synchronized operation of the media device corresponding to the tasks requested.

For example, in one method of operation, upon transmission of the task signal to the media device, the disc transport moves along the first slide member to the rotatable disc carousel, wherein the rotatable disc carousel rotates about a vertical axis, (if necessary), to align the holes of the one or more discs located in the supply receptacle with the engagement mechanism located thereabove. The engagement mechanism is lowered along the second slide member until the flanges, extending from the engagement fingers, become flush with the top disc residing in the supply receptacle. The engagement fingers are then separated so that the top disc is separated from the adjacent disc residing in the one or more supply receptacles. The engagement mechanism then raises along the second slide member with a disc to its original position, e.g., above the rotatable disc carousel, so as to prevent interference with the plurality of receptacles of the rotatable disc carousel during transferring of the engaged disc.

The disc is moved along the first slide member to one of the recording devices. Preferably, the recording tray of the recording device is extended so that the center portion of the disc attached to the engagement mechanism is substantially aligned with the center of the recording tray of the recording device. The engagement mechanism is then lowered along the second slide member proximate to the recording tray and releases the disc. Upon placement of the disc into the recess formed on the recording tray, the engagement mechanism returns to an original position and the recording tray retracts into the recording device, wherein information is then recorded onto the disc. The operation of transferring discs to the plurality of recording devices is repeated until each recording device is in use; the entire task is complete, or otherwise.

Upon completion of recordation of data to the disc, the recording tray extends and the disc engagement mechanism lowers and once again engages the disc and raises it to the original position. The disc printing tray then moves into an extending position and the disc transport, if necessary, aligns the center of the disc with the center of the recess formed in the disc-printing tray. The engagement mechanism then lowers the disc onto the print tray in a similar fashion that was performed with the disc-recording device. The engagement mechanism releases the disc and returns to an upward portion.

The disc-printing tray then moves in synchronization with the print heads of the processing station to effectuate printing to the surface of the disc. During this process, because of the decoupling of the disc transport and the processing station, the disc transport moves back to the disc supply cartridge to retrieve another disc and place the disc into one of the empty disc recording devices as discussed above. It should be appreciated that this may be performed during printing to the disc.

Upon completion of the printing to the disc, and advantageously during recordation of data to the disc located in the recording device, the processing station tray extends to its extended position. The disc transport then aligns itself with the disc located in the print tray, if necessary, and engages the completed disc. The disc is then transported to one of the one or more storage receptacles, wherein the rotatable disc carousel rotates thereby aligning the storage receptacle with the engagement mechanism thereabove, preferably in a similar fashion to that of the placement into the recess portion of the print tray and recording tray.

The disc transport then moves to a second recording device, removes the disc from the recording device tray, and places it into the print tray to be printed to. It should be appreciated that this cycle continues until the all of the selected tasks have been completed or the disc from the disc supply receptacle has been exhausted.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only three of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. An apparatus for transporting a storage disc comprising:
a disc transport movable along a first member and a second member, the disc transport including:
a engagement mechanism for selective engagement of at least one disc;
a processing station for printing to the at least one disc, the processing station including:
one or more print heads movable along a print axis;
a movable print tray adapted to receive the at least one disc from the disc transport;
a rotatable disc carousel including:
a plurality of disc receptacles adapted to receive one or more discs; and
a control unit for controlling the functions of the media device;
wherein the disc transport and the one or more prints heads are adapted to move independent of each other.

2. The apparatus of claim 1, further comprising a plurality of recording devices for recording to the at least one disc, the plurality of recording devices including:
a movable recording tray adapted to receive and record to the at least one disc from the disc transport;

3. The apparatus of claim 2, wherein the disc transport moves the engagement mechanism along the second member in a first engagement axis that is in general alignment with the recording tray located in an open position for receiving the at least one disc therein.

4. The apparatus of claim 1, wherein the disc transport moves the engagement mechanism along the second member in a second engagement axis that is in general alignment with the print tray located in an open position for receiving the at least one disc therein.

5. The apparatus of claim 1, wherein the rotatable disc carousel includes a first receptacle and a second receptacle and wherein the disc transport moves the engagement mechanism along the second member in either a third engagement axis that is in general alignment with the first receptacle or a fourth engagement axis that is in alignment with the second receptacle for receiving the at least one disc therein.

6. The apparatus of claim 5, wherein the rotatable disc carousel rotates along the carousel axis thereby positioning a third receptacle in either the third engagement axis or the fourth engagement axis for alignment of the engagement mechanism thereabove.

7. The apparatus of claim 1, wherein the first member and the second member are axially displaced from the print axis with respect to one another.

8. A method for operating a media device comprising the steps of:
providing a media device comprising:
a disc carousel including:
a plurality of disc receptacles, wherein at least one receptacle includes at least one disc having a hole;
a disc transport including:
a engagement mechanism;
a first slide member for movement of the disc transport about a first axis; and
a second slide member for movement of the disc transport about a second axis;
a control unit adapted to control the functions of the media device;
moving the engagement mechanism along the first axis to a first engagement axis using the disc transport;
rotating the disc carousel for aligning a first receptacle with the engagement mechanism of the disc transport;
moving the engagement mechanism along the first engagement axis to partially dispose the engagement mechanism within the hole of a first disc located within the first receptacle of the disc carousel; and
engaging the first disc.

9. The method of claim 8, further comprising the steps of:
providing at least one media component having a movable tray adapted to receive the first disc from the disc transport;
extending a first movable tray of a first media component to an open position;
moving the engagement mechanism and the engaged first disc along the first axis to a second engagement axis that is in alignment with the first movable tray of the first media component;
disengaging the first disc into the first movable tray of the first media component;
retracting the first movable tray to a closed position within the first media component; and
processing the first disc, wherein the step of processing the first disc comprises the step of printing, recording, or both.

10. The method of claim 9, further comprising the steps of:
moving the engagement mechanism along the first axis to the first engagement axis using the disc transport;
moving the engagement mechanism along the first engagement axis to partially dispose the engagement mechanism within the hole of a second disc located within a first receptacle of the disc carousel; and
engaging the second disc;
moving the engagement mechanism and the engaged second disc along the first axis to a third engagement axis that is in alignment with a second movable tray of a second media component;
disengaging the second disc into the second movable tray of the second media device; and
processing the second disc, wherein the step of processing the second disc comprises the step of printing, recording, or both.

11. The method of claim 10, further comprising the steps of:
engaging a processed disc form the first media component.
moving the engagement mechanism and the processed disc along the first axis to a fourth engagement axis that is in general alignment with a second receptacle of the disc carousel axis; and
disengaging the processed disc into the second receptacle.

12. The method of claim 10, further comprising the steps of:
engaging a processed disc form the second media component.
rotating the disc carousel along the carousel axis so that a third receptacle is in general alignment with either the third engagement axis or the fourth engagement axis;
moving the engagement mechanism and the processed disc along the first axis to either the third engagement axis or the fourth engagement axis; and
disengaging the processed disc into the second receptacle

13. The method of claim 8, wherein the at least one media component is a printer assembly adapted for printing to the selected disc, the printer assembly further comprising one or more print heads movable along a print axis.

14. The method of claim 13, wherein the disc transport and the one or more prints heads are adapted to move independent of each other

15. The method of claim 8, wherein the at least one media component is a digital recording device adapted for recording to the selected disc.

16. An apparatus for transporting a storage disc comprising:
a disc transport movable along a first axis and a second axis, the disc transport including:
a engagement mechanism for selective engagement of at least one disc;
a print assembly for printing to the at least one disc, the print assembly including:
a movable print tray adapted to receive the at least one disc from the disc transport;
a plurality of recording devices for recording to the at least one disc, the plurality of recording devices including:
a movable recording tray adapted to receive and record to the at least one disc from the disc transport
a rotatable disc carousel including:
a plurality of disc receptacles adapted to receive one or more discs;
wherein the rotatable disc carousel rotates about a carousel axis that is substantially parallel to the second axis; and
a control unit for controlling the functions of the media device;
wherein the disc transport and the rotatable disc carousel are adapted to move independent of each other and wherein the print tray and the recording tray are located adjacent to one another and adapted for movement parallel to the first axis.

17. The apparatus of claim 16, wherein the disc transport moves the engagement mechanism along a first engagement axis that is in general alignment with the recording tray located in an open position for receiving the at least one disc therein.

18. The apparatus of claim 16, wherein the disc transport moves the engagement mechanism along a second engagement axis that is in general alignment with the print tray located in an open position for receiving the at least one disc therein.

19. The apparatus of claim 16, wherein the rotatable disc carousel includes a first receptacle and a second receptacle and wherein the disc transport moves the engagement mechanism along either a third engagement axis that is in general alignment with the first receptacle or a fourth engagement axis that is in alignment with the second receptacle for receiving the at least one disc therein.

20. The apparatus of claim 19, wherein the rotatable disc carousel rotates along the carousel axis thereby positioning a third receptacle in either the third engagement axis or the fourth engagement axis for alignment of the engagement mechanism thereabove.
